(19) United States
(12) Patent Application Publication
(10) Pub. No.: US 2007/0267562 A1
(43) Pub. Date: Nov. 22, 2007

(54) Stand assembly for a screen partition

(76) Inventor: Sheng-Hung Hsu, Kaohsiung Hsien (TW)

Correspondence Address: Rabin & Berdo, P.C., 1101 14th Street, Suite 500, Washington, DC, 20005, US

(21) Appl. No.: 11/434,118

(22) Filed: May 16, 2006

(51) Int. Cl. F16M 11/00

(52) U.S. Cl. 248/682

(57) ABSTRACT

A stand assembly for a screen partition is mounted in a post of the screen partition and has a base bracket, a rod assembly and a linking string. The base bracket is capable to be erected on a ground. The rod assembly is detachably mounted on the base bracket and has multiple linking rods. The linking rods are hollow and are detachably and foldably connected to the base bracket in serial. The linking string is mounted through and links up the linking rods of the rod assembly. When the positioning rod are folded into multiple linking rods, the linking rods are linked together by the linking string such that the rod assembly is convenient to be carried, moved or stored.

### BACKGROUND OF THE INVENTION

1. Field of the Invention

The present invention relates to a stand assembly, and more particularly to a stand assembly for a screen partition.

2. Description of the Related Art

At an exhibition, in an indoor exhibition or an outdoor exhibition, multiple portable screen partitions are erected to divide the exhibition field into several separate segments and are arranged in line to lead people in a certain direction for a well-ordered visiting.

With reference to FIG. 8, a conventional screen partition comprises two stand assemblies (91), two posts (92) and a panel (93). Each of the stand assemblies has a base bracket (912) and a positioning rod (911). The base bracket (912) is capable to be erected on a ground. The positioning rod (911) is mounted securely on the bracket (912). The posts (92) are hollow and are mounted respectively on the base brackets (912) around the positioning rods (911). The panel (93) is flexible and taut, has two side edges respectively mounted on the posts (92) and forms a wall when the posts (92) are placed in an appropriate space.

However, the positioning rods (911) of the conventional screen partition are not foldable so that a user is hard to carry or move the positioning rods (911), and the positioning rods (911) are easy to collide with another objects when being carried or moved. Further, to store the conventional position rods (911) takes a large space and is inconvenient.

### SUMMARY OF THE INVENTION

The primary objective of the present invention is to provide a stand assembly for a screen partition and the stand assembly is convenient to be carried and moved and is easy to be put away tidily after work.

The stand assembly in accordance with the present invention comprises a base bracket, a rod assembly and a linking string.

The base bracket is capable to be erected on a ground.

The rod assembly is detachably mounted on the base bracket and has multiple linking rods. The linking rods are hollow and selective to be detachably and foldably connected to the base bracket in serial.

The linking string is mounted through and links up the linking rods of the rod assembly and has two ends extending respectively out of two ends of the rod assembly. The linking string links up the linking rods of the rod assembly such that the rod assembly is convenient to be carried or moved or stored.

Other objectives, advantages and novel features of the invention will become more apparent from the following detailed description when taken in conjunction with the accompanying drawings.

### BRIEF DESCRIPTION OF THE DRAWINGS

FIG. 1 is an exploded perspective view of a stand assembly for a screen partition in accordance with the present invention;

FIG. 2 is a perspective view of a screen partition with two stand assemblies in FIG. 1;

FIG. 3 is an enlarged front view in partial section of the stand assembly in FIG. 1, wherein a bottom limiting ring of a linking string of the stand assembly is received in a second sleeve of the stand assembly;

FIG. 4 is an enlarged front view in partial section of the stand assembly in FIG. 1, wherein two linking rods of the stand assembly are inserted into a first sleeve of the stand assembly;

FIG. 5 is an enlarged perspective view of the stand assembly in FIG. 1, wherein a lid of the stand assembly is mounted on a linking rod of the stand assembly;

FIG. 6 is an operational perspective view of the stand assembly in FIG. 1, wherein a rod assembly of the stand assembly is folded;

FIG. 7 is an enlarged side view in partial section of the stand assembly in FIG. 1, wherein a top limiting ring of the linking string of the stand assembly is received in the lid of the stand assembly; and

FIG. 8 is a perspective view of a conventional screen partition in accordance with the prior art.

### DETAILED DESCRIPTION OF THE PREFERRED EMBODIMENT

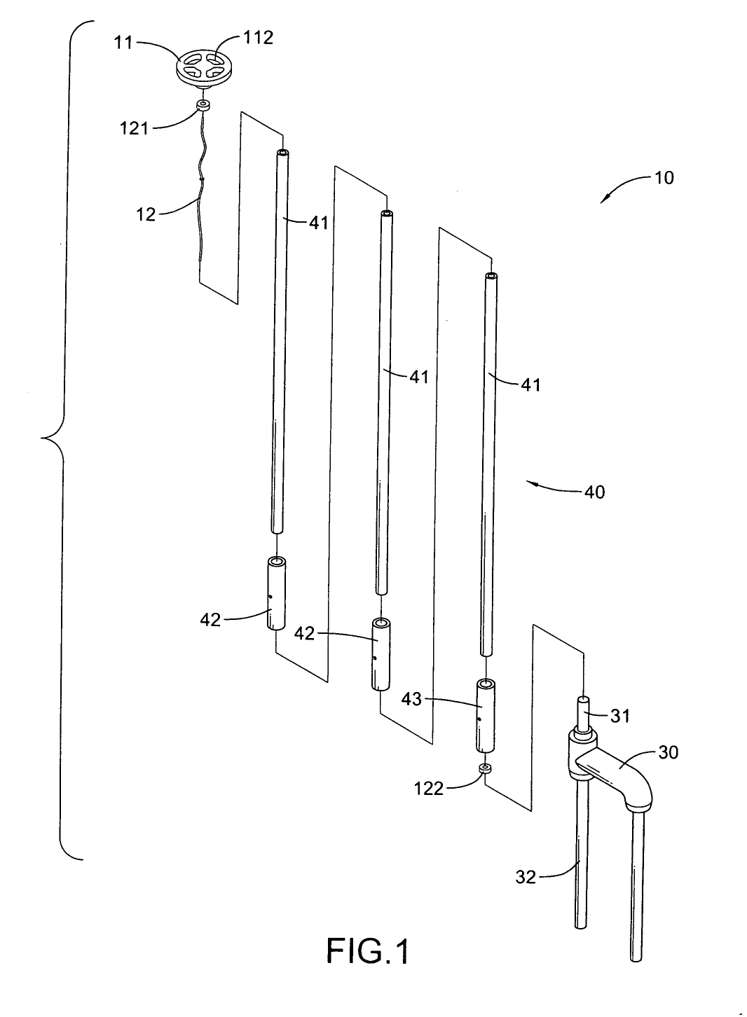

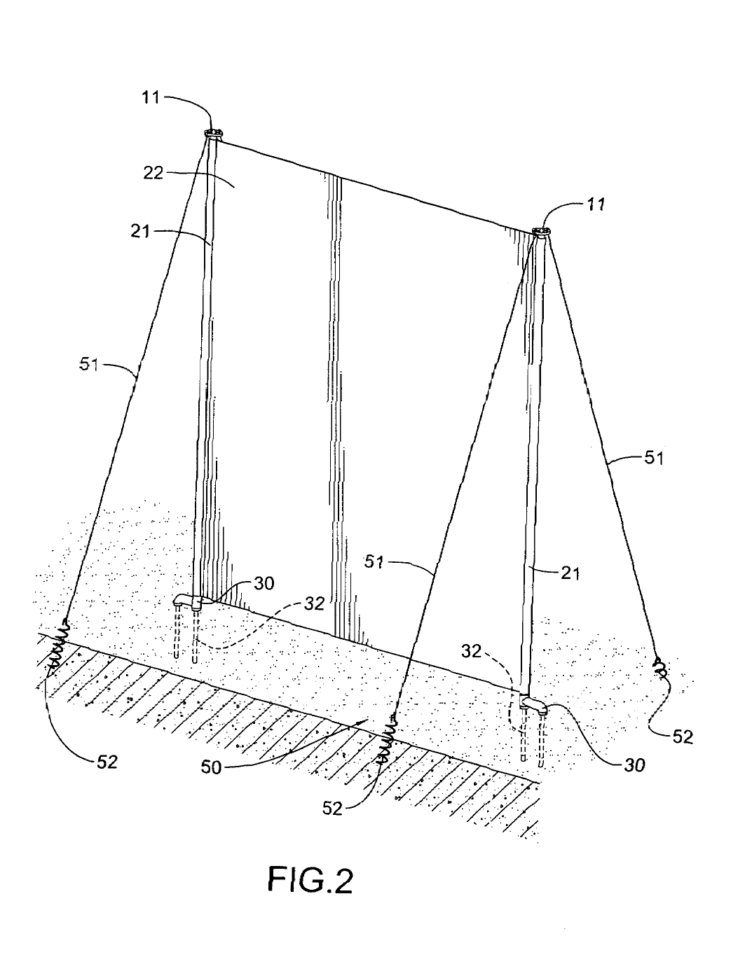

With reference to FIGS. 1 and 2, a screen partition has two stand assemblies (10) in accordance with the present invention, two post (21) and a panel(22).

Each of the stand assemblies (10) comprises a base bracket (30), a rod assembly (40), an optional lid (11), a linking string (12) and an optional fluke assembly (50).

The base bracket (30) is capable to be erected on a ground and has a top, a bottom, an optional mounting nipple (31) and at least one optional mounting claw (32). The mounting nipple (31) is formed on and protrudes from the top of the base bracket (30). The at least one mounting claw (32) is formed on and protrudes from the bottom of the bracket (30) and is capable to be inserted into the ground for securely erecting the base bracket (30) on the ground.

The rod assembly (40) is detachably mounted on the base bracket (30) and has multiple linking rods (41), multiple optional first sleeves (42) and an optional second sleeve (43). The linking rods (41) are hollow, are detachably connected to the base bracket (30) in serial and each of the linking rods (41) has an inside diameter, a top end and a bottom end.

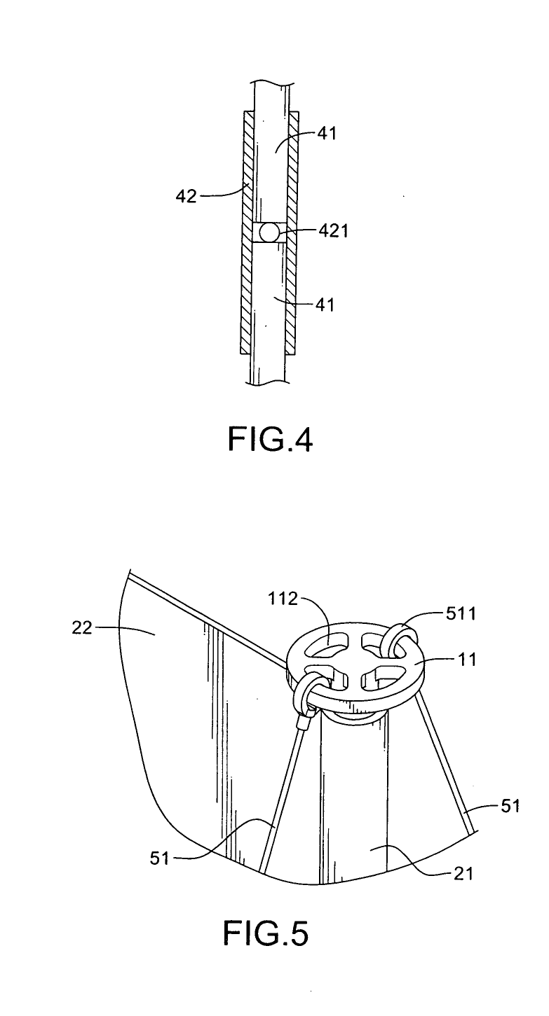

With further reference to FIG. 4, each of the first sleeves (42) is hollow, is detachably mounted between two adjacent linking rods (41) and has a top end, a bottom end, an inside wall and a limiting protrusion (421). The top end of the first sleeve (42) is mounted around the bottom end of one of the adjacent linking rods (41). The bottom end of the first sleeve (42) is mounted around the top end of the other one of the adjacent linking rods (41). The limiting protrusion (421) is formed on and protrudes from the inside wall of the first sleeve (42) and is squeezed between the bottom end and the top end of the adjacent linking rods (41) to keep the first sleeve (42) from sliding relatively to the adjacent linking rods (41).

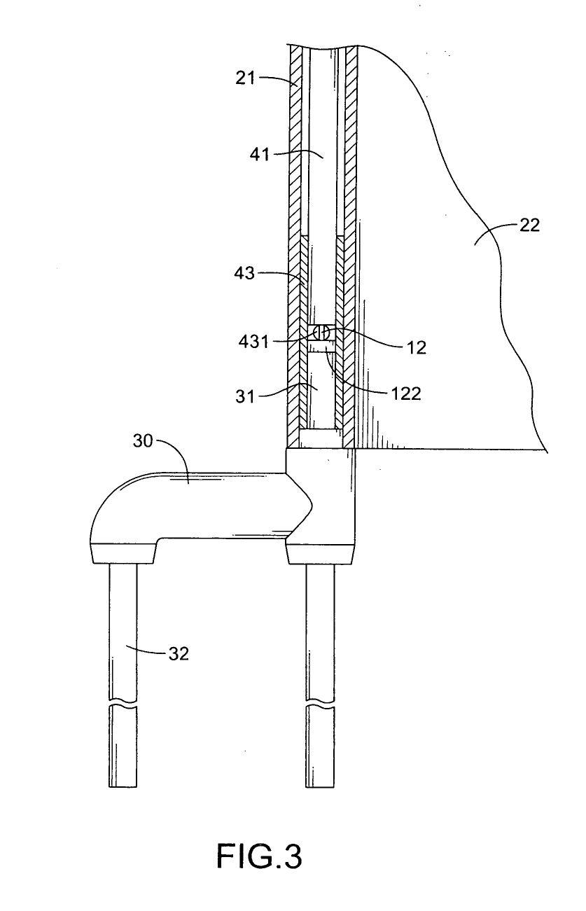

With further reference to FIG. 3, the second sleeve (43) is hollow, is detachably mounted between a lowermost linking rod (41) and the base bracket (30) and has a top end, a bottom end, an inside wall and a limiting protrusion (431). The top end of the second sleeve (43) is mounted around the bottom end of the lowermost linking rod (41). The bottom end of the second sleeve (43) is mounted around the mounting nipple (31) of the base bracket (30). The limiting protrusion (431) is formed on and protrudes from the inside wall of the second sleeve (43) and is squeezed between the bottom end of the linking rod (41) to keep the second sleeve (43) from sliding relatively to the linking rod (41).

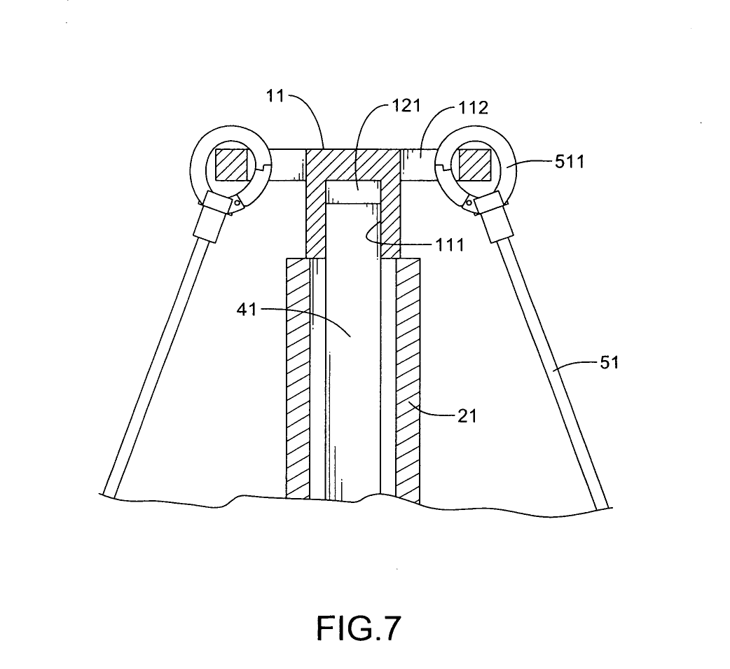

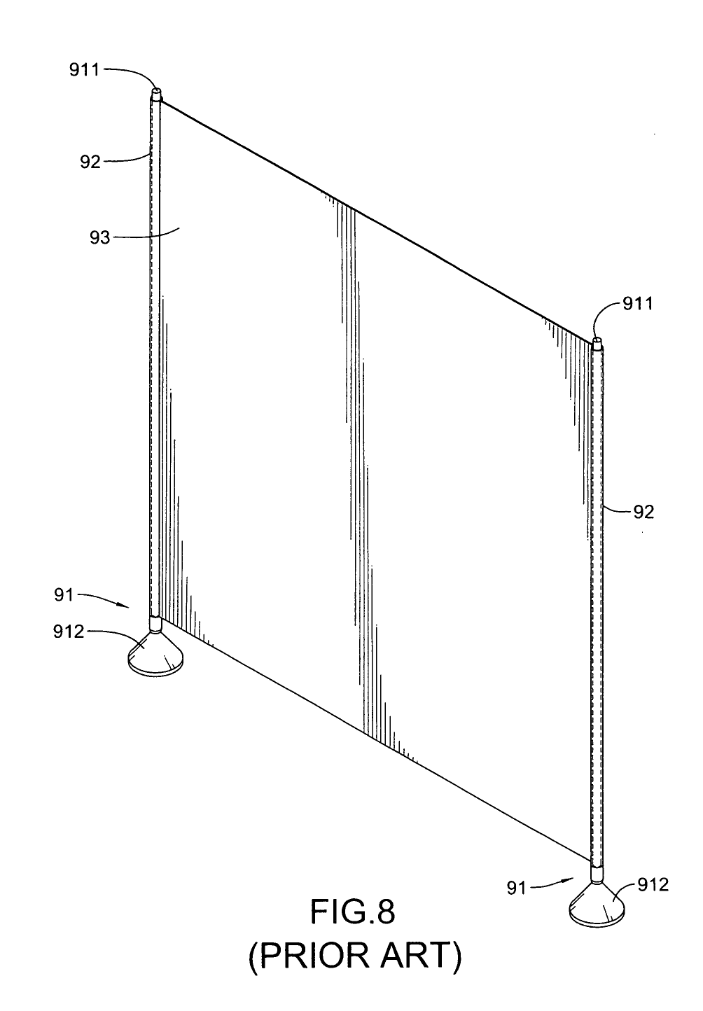

With further reference to FIG. 7, the lid (11) is detachably mounted on the rod assembly (40) and has an outside diameter, a bottom, at least one optional through hole (112) a mounting hole (111). The at least one through hole (112) is formed through the lid (11). The mounting hole (111) is formed in the bottom of the lid (11), is mounted around the top end of an uppermost linking rod (41).

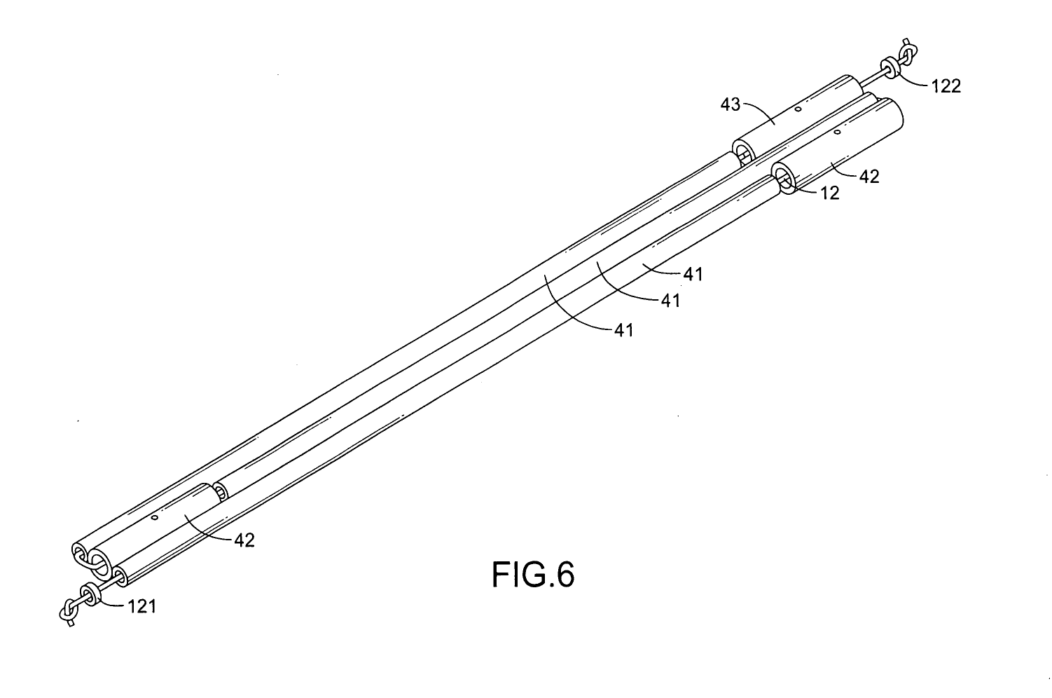

With further reference to FIG. 6, the linking string (12) is mounted through and links up the linking rods (41), the first sleeves (42) and the second sleeve (43) and has a top end, a bottom end, an optional top limiting ring (121) and an optional bottom limiting ring (122). The top and bottom ends of the linking string (12) extend respectively out of two ends of the rod assembly (40).

With further reference to FIG. 7, the top limiting ring (121) is mounted at the top end of the string (12), is selectively received in the mounting hole (111) of the lid (11), abuts with the top end of the uppermost linking rods (41) and has an outside diameter. The outside diameter of the top limiting ring (121) is slightly larger than the inside diameter of the linking rod (41) and blocks the linking rods (41) to keep the linking rods (41) from detaching from the linking string (12).

With further reference to FIG. 3, the bottom limiting ring (122) is mounted at the bottom end of the string (12), is selectively mounted in the bottom end of the second sleeve (43) and is squeezed between the mounting nipple (31) of the base bracket (30) and the limiting protrusion (431) of the second sleeve (43) to keep the bottom limiting ring (122) from sliding out of the second sleeve (43).

The linking rods (41), first sleeves (42) and second sleeve (43) of the rod assembly (40) are linked together by the linking string (12) such that the rod assembly (40) is foldable and convenient to be carried or moved and is unlikely to collide with another objects when being carried or moved. Further, the space for storing the folded rod assembly (40) is reduced.

The fluke assembly (50) is mounted on the lid (11) and has two positioning strings (51) and two flukes (52). Each of the positioning strings (51) has a top end, a bottom end and an optional fastener (511).

With further reference to FIG. 5, the top end of the positioning string (51) is connected to the lid (11). The fastener (511) is mounted at the top end of the positioning string (51) and clasps the lid (11) through the at least one through hole (112) of the lid (11) to connect the top end of the positioning string (51) to the lid (11).

The flukes (52) are respectively mounted at the bottom ends of the positioning strings (51) and are capable to be anchored into the ground to enhance a stability of erecting the stand assembly (10).

The posts (21) are hollow, are respectively mounted on the base brackets (30) of the stand assemblies (10), are respectively mounted around the rod assemblies (40) and each of the posts (21) has an inside diameter. The inside diameter of the post (21) is smaller than the outside diameter of the lid (11) such that the post (21) is blocked by the lid (11) and keep the stand assembly (10) inside the post (21).

The panel (22) is flexible and taut, has two side edges respectively mounted on the posts (21), and forms a wall when the posts (21) are placed in an appropriate space.

Even though numerous characteristics and advantages of the present invention have been set forth in the foregoing description, together with details of the structure and features of the invention, the disclosure is illustrative only. Changes may be made in the details, especially in matters of shape, size and arrangement of parts within the principles of the invention to the full extent indicated by the broad general meaning of the terms in which the appended claims are expressed.

What is claimed is:

1. A stand assembly for a screen partition comprising:
a base bracket having a top and a bottom;
a rod assembly detachably mounted on the base bracket and having
multiple linking rods being hollow, detachably connected to the base bracket in serial and including an uppermost linking rod and a lowermost linking rod, and each of the linking rods having
an inside diameter;
a top end; and
a bottom end; and
a linking string mounted through and linking up the linking rods of the rod assembly and having a top end and a bottom end extending respectively out of two ends of the rod assembly.

2. The stand assembly as claimed in claim 1, wherein
the rod assembly further has multiple first sleeves and each of the first sleeves being hollow, detachably mounted between two adjacent linking rods and having
an inside wall;
a top end mounted around the bottom end of one of the adjacent linking rods;
a bottom end mounted around the top end of the other one of the adjacent linking rods; and
a limiting protrusion formed on and protruding from the inside wall of the first sleeve and squeezed between the bottom end and the top end of the adjacent linking rods to keep the first sleeve from sliding relatively to the adjacent linking rods; and
the linking string is further mounted through and links up the first sleeves of the rod assembly.

3. The stand assembly as claimed in claim 2, wherein
the base bracket further has a mounting nipple formed on and protruding from the top of the base bracket;
the rod assembly further has a second sleeve being hollow, detachably mounted between the lowermost linking rod and the base bracket and having
an inside wall;
a top end mounted around the bottom end of the lowermost linking rod;
a bottom end mounted around the mounting nipple of the base bracket; and
a limiting protrusion formed on and protruding from the inside wall of the second sleeve and squeezed between the bottom end of the lowermost linking rod to keep the second sleeve from sliding relatively to the lowermost linking rod;
the stand assembly further comprises a lid detachably mounted on the rod assembly and having
an outside diameter;
a bottom; and
a mounting hole formed in the bottom of the lid, mounted around the top end of the uppermost linking rod; and
the linking string is further mounted through and links up the second sleeve of the rod assembly and further has
a top limiting ring mounted on the top end of the string, received in the mounting hole of the lid and abutting with the top end of the uppermost linking rod and having an outside diameter larger than the inside diameter of the linking rod; and
a bottom limiting ring mounted at the bottom end of the string and received in the bottom end of the second sleeve, squeezed between the mounting nipple of the base bracket and the limiting protrusion of the second sleeve.

4. The stand assembly as claimed in claim 3, wherein the base bracket further has at least one mounting claw formed on and protruding from the bottom of the bracket.

5. The stand assembly as claimed in claim 4, wherein the stand assembly further comprises a fluke assembly mounted on the lid and having
two positioning strings and each of the positioning string having
a top end connected to the lid; and
a bottom end; and
two flukes respectively mounted at the bottom ends of the positioning strings.

6. The stand assembly as claimed in claim 5 wherein
the lid further has at least one through hole formed therethrough; and
each of the positioning strings further has a fastener mounted at the top end of the positioning string and clasping the lid through one of the at least one through hole of the lid to connect the top end of the positioning string to the lid.

7. The stand assembly as claimed in claim 1, wherein the base bracket further has at least one mounting claw formed on and protruding from the bottom of the bracket.

8. The stand assembly as claimed in claim 2, wherein the base bracket further has at least one mounting claw formed on and protruding from the bottom of the bracket.
